(19) United States
(12) Patent Application Publication
(10) Pub. No.: US 2026/0163135 A1
(43) Pub. Date: Jun. 11, 2026

(54) COVER FOR AN ELECTROCHEMICAL CELL

(71) Applicant: SAFT, Levallois-Perret (FR)

(72) Inventors: Christian DUPUY, NERSAC (FR); William PUISSESSEAU, SMARVES (FR); Patrice TERROCHAIRE, SAINT-BENOÎT (FR); Michaël VENIEN, VOUZAILLES (FR)

(73) Assignee: SAFT, Levallois-Perret (FR)

(21) Appl. No.: 18/707,786

(22) PCT Filed: Nov. 15, 2022
(86) PCT No.: PCT/EP2022/081936

§ 371 Date: May 6, 2024

(30) Foreign Application Priority Data
Dec. 22, 2021 (FR) FR2114280

(51) Int. Cl. H01M 50/152; H01M 50/159; H01M 50/342; H01M 50/588; H01M 50/627

(52) U.S. Cl. CPC H01M 50/152; H01M 50/159; H01M 50/3425; H01M 50/588; H01M 50/627; H01M 2200/20

(57) ABSTRACT

A cover for an electrochemical cell, a method for producing it and a cell comprising the cover are provided. The cover includes a ring with an outer circumference and an inner circumference, a crown-shaped boss located between the inner circumference and the outer circumference, two or more circular arc-shaped planar areas located between the crown-shaped boss and the outer circumference of the ring, and a number of projections extending from the crown-shaped boss toward the outer circumference along a non-radial axis, with a thinned region being present on at least one of the projections and/or on the crown-shaped boss and/or on at least one of the planar areas. The cover makes it possible to increase the useful volume inside the cell.

### TECHNICAL FIELD OF THE INVENTION

The technical field of the present invention is that of electrochemical cells and more particularly that of covers for electrochemical cells.

### BACKGROUND OF THE INVENTION

There are two large categories of electrochemical cell, primary electrochemical cells (not rechargeable) sometimes called simply a battery, and secondary electrochemical cells (rechargeable) sometimes called accumulators.

The family of primary electrochemical cells comprises in particular cells of the Li/SO₂, Li/SOCl₂, Li/SOCh, Li/MnO₂ and Li/CFₓ type.

The family of secondary electrochemical cells comprises in particular cells of the lithium-ion, Ni/MH and Ni/Cd type.

The primary or secondary electrochemical cells may be constructed according to various assemblies, for example as a spiral or wound. They are generally in a cylindrical or prismatic shape and comprise a container enclosing an electrode plate group, said container being closed by a cover. In the case of a spirally wound electrochemical cell, the electrode plate group is formed by a positive electrode and a negative electrode wound together and separated by a separator. In the case of a electrochemical cell in the form of a winding, the electrode plate group comprises an electrode mass or coil separated from the electrode of opposite polarity by a separator, the electrode of opposite polarity covering the inner wall of the container of the cell. In primary electrochemical cells, the electrolyte is the cathode. The term liquid cathode is sometimes used. In secondary electrochemical cells, the electrode plate group is impregnated with electrolyte.

These types of constructions make it possible to obtain electrochemical cells with high power and/or high energy. It is therefore necessary to make their use safe, in particular in the case of use of the cell outside of nominal conditions such as for example during accidental overload, in the presence of a short-circuit, or during exposure to a temperature higher than the maximum rated temperature. This is because this can create a risk of explosion and lead to electrochemical reactions which generate gases in the container of the cell. The accumulation of these gases leads to an increase in the internal pressure of the cell, which can lead to violent bursting of the container and to the projection of corrosive chemical compounds harmful to the environment and people in the immediate vicinity.

Many safety devices exist in which the cover of the container plays a primordial role. Documents CN208986032U and CN109148747 describe container closure systems comprising, under the cover, an anti-deflagration diaphragm separating a buffer volume. Here, when the internal pressure increases, the diaphragm deforms to allow the gas to spread into said buffer volume situated under the cover.

However, such devices have the major drawback of limiting the available useful volume within the container for the electrode plate group and therefore limiting the capacity of the cell.

Thus, there is a need to provide a cover for an electrochemical cell that allows secure closure of the cell by avoiding explosion, while increasing the internal volume and consequently the capacity of said cell.

### SUMMARY OF THE INVENTION

The first subject of the invention is a cover for an electrochemical cell, comprising:
a cover for an electrochemical cell, comprising:
   a ring, said ring having an outer circumference and an inner circumference,
   a crown-shaped boss located between the inner circumference and the outer circumference,
   at least two circular arc-shaped planar areas, located between the crown-shaped boss and the outer circumference of the ring, the cover being seen in a direction perpendicular to the plane of the ring,
   at least four projections extending from the crown-shaped boss toward the outer circumference along a non-radial axis,
wherein a thinned region is present on at least one of these four projections and/or on the crown-shaped boss and/or on at least one of the at least two planar areas.

According to one embodiment, the cover comprises two separate interfacing regions of identical or opposite polarities (6, 7).

According to one embodiment the first interfacing region (6) is located between the ring-shaped boss and the outer circumference of the ring, and the second interfacing region (7) of the same or opposite polarity to the first polarity is located in a space defined by the inner circumference of the ring.

According to one embodiment, the second interfacing region is insulated from the cover by a glass-metal feedthrough comprising a glass insulator (10) and a metal fixing means (11), said fixing means being fixed to the cover by welding.

According to one embodiment, the first interfacing region is a negative polarity electrode connecting region and the second interfacing region is a positive polarity electrode connecting region.

According to one embodiment, the thinned region is rectangular, chevron or almond-shaped.

According to one embodiment, each projection includes a thinned region.

According to one embodiment, the at least four projections each extend along a non-radial direction axis, wherein no direction axis is parallel to another.

According to one embodiment, the cover comprises between 2 and 4 planar regions in the form of an arc of a circle (9), located between the crown-shaped boss and the outer circumference of the ring, the cover being viewed in a direction perpendicular to the plane of the ring.

According to one embodiment, the height of the ring is greater than or equal to 1.6 mm and less than 4 mm, preferably between 2 and 3 mm.

According to one embodiment, the cover includes an orifice for filling a cell with an electrolyte (8), the orifice being in a hollow region of the surface of the ring.

According to one embodiment, the cover is made of stainless steel, nickel-plated steel or aluminum.

The invention further provides an electrochemical cell comprising:
a container housing an electrode plate group,
an end forming a base, and
an end opposite the end forming a base,
wherein the end opposite to the end forming a base is closed by a cover (1) as defined above.

According to one embodiment of the electrochemical cell, the volume allocated to a set of connections, an electrolyte and the electrochemical plate group makes up at least 95% of the volume available in the container.

According to one embodiment the electrochemical cell is of the lithium-ion, Ni/MH or Ni/Cd type.

According to one embodiment the electrochemical cell is of the primary lithium type selected from the group comprising: LiMnO₂, LiCFₓ, LiSO₂, LiSOCl₂ and LiSO₂Cl₂.

The invention further provides a method of manufacturing the cover as defined above, comprising the steps of:
(a) stamping a sheet, to form a ring having:
   an outer circumference (2a) and an inner circumference (2b),
   a crown-shaped boss (3) located between the inner circumference (2b) and the outer circumference (2a),
   at least two circular arc-shaped planar areas (9), located between the crown-shaped boss and the outer circumference of the ring, the cover being seen in a direction perpendicular to the plane of the ring,
   at least four projections (4) extending from the crown-shaped boss toward the outer circumference along a non-radial axis;
(b) forming a thinned region (5) on at least one of the four projections (4) and/or the crown-shaped boss (3) and/or on at least one of the at least two planar areas (9); step (b) being performed after step (a) or before step (a) at the locations provided on the sheet for creating the crown-shaped boss (3) and said at least four projections (4) by stamping.
(c) providing an insulated interfacing terminal (7) in the space defined by the inner circumference (2b) of the ring;
(d) welding the interfacing terminal to the part obtained in step (b).

According to one embodiment of the method, step (b) is carried out by stamping or by removing material.

The present invention makes it possible to overcome the drawbacks of the prior art by providing a cover making it possible to increase the useful volume inside the container, which has the consequence of freeing-up more space available for the electrode plate group, thus making it possible to increase the quantity of active material, thereby leading to an increase in the capacity of the cell. In fact, unlike the prior art, the cover of the invention does not provide a buffer volume inside the container, but it is the deformation of the cover towards the outside which acts as a buffer volume without adding bulkiness both inside and outside the container. In addition, the cover according to the invention has better pressure resistance compared to the standard cover and the deformation of the cover according to the invention is controlled. Apart from that, another advantage of the present invention lies in the significant saving of material necessary for the production of the cover.

### BRIEF DESCRIPTION OF THE DRAWINGS

FIG. 1 shows a cover (1) according to one of the embodiments of the invention comprising:
an outer circumference (2a) and an inner circumference (2b)
a crown-shaped boss (3)
four projections (4)
two thinned regions (5)
a negative electrode connection region (6)
an electrolyte filling orifice (8).
two planar regions (9).
the center of the cover incorporates a junction that can be of the glass-metal feedthrough (TVM) type on which the connection region of the positive electrode is located (this junction is not shown in this figure).

FIG. 2 shows a thinned region in three different shapes: (a) an almond shape, (b) rectangular and (c) as a chevron.

FIG. 3 shows a glass-metal seal comprising a metal base 11 into which a nail-shaped terminal is inserted. The head of the nail 7 serves as a terminal of the cell, for example the positive terminal. The stem of the nail is intended to be connected to the electrodes of a given polarity, for example the positive electrodes. The terminal is insulated from the base by a glass insulator 10.

FIG. 4 shows four separate embodiments of a cover according to the invention.

Each of these embodiments is shown with the glass-metal seal (left-hand column and without this junction right-hand column).

Embodiment I: corresponds to that shown in FIG. 1 above. This embodiment is particularly suitable for re-employing components derived from electrochemical cells of A, AA or 1/2AA format.

Embodiment II: differs from Embodiment I in that it does not include an electrolyte filling orifice and in that the cover includes a support for the glass-metal feedthrough (TVM) at its center. This embodiment is particularly suitable for re-employing components derived from electrochemical cells of format C or D

Embodiment III: this differs from Embodiment I in that it includes four planar regions 9.

Embodiment IV: this differs from Embodiment II in that it includes four planar regions 9.

FIG. 5 is a graph representing the deformation along the direction of the longitudinal axis of the cell, measured in millimeters, of a standard cell (curve with square dots) and cells according to the invention (all the other curves), as a function of their internal pressure expressed in bar.

FIG. 6 represents a schematic superposition of a section of a cover 21 according to the invention shown in dotted lines, and of a section of a cover according to the prior art 22 shown in solid lines. This figure makes it possible to visualize the gain of useful internal volume.

FIG. 7 is a graph representing the evolution of internal pressure (in MPa) as a function of time (in seconds) for cells comprising either a thinned region on at least one of the four projections (dotted lines), or at least one thinned region situated on the crown-shaped boss (solid lines).

FIG. 8 is a side view of a cover according to the prior art (A) and of a cover according to an embodiment of the invention (B).

### DESCRIPTION OF EMBODIMENTS OF THE INVENTION

The first subject of the invention is a cover for an electrochemical cell, comprising:
a ring, said ring having an outer circumference and an inner circumference,
a crown-shaped boss located between the inner circumference and the outer circumference,
at least two planar regions in the form of an arc of a circle, located between the crown-shaped boss and the outer circumference of the ring, the cover being seen in a direction perpendicular to the plane of the ring,
at least four projections extending from the crown-shaped boss towards the outer circumference along a non-radial axis,
   wherein a thinned region is present on at least one of these four projections and/or on the crown-shaped boss and/or on at least one of the at least two planar regions.

### Projections and Thinned Region

The term “projection” is understood to mean something forming a relief.

The term “non-radial axis” is understood to mean an axis which does not pass through the center of the ring.

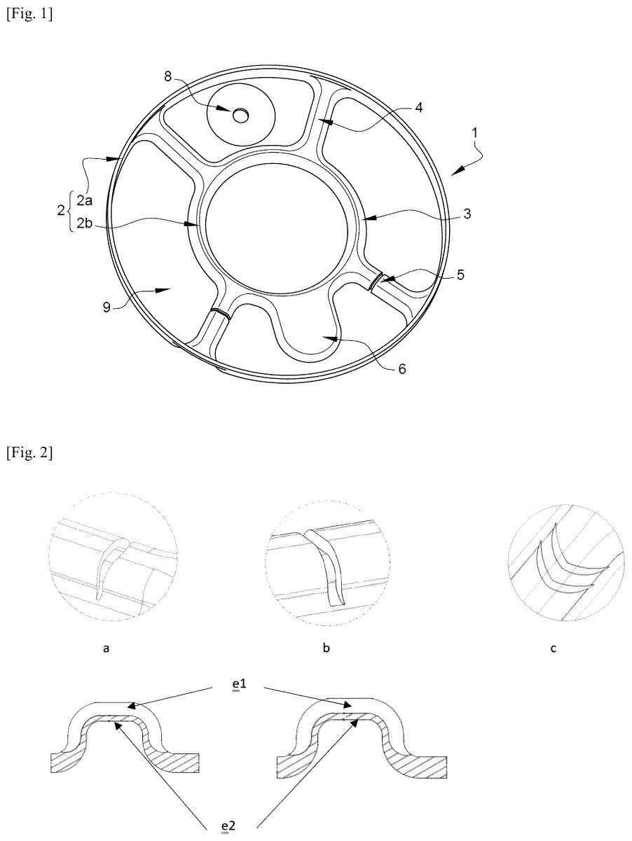

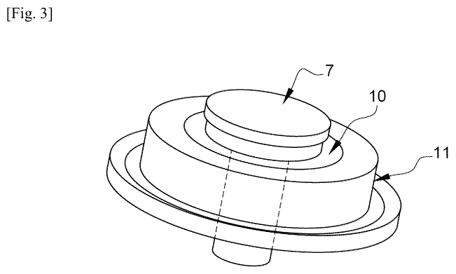

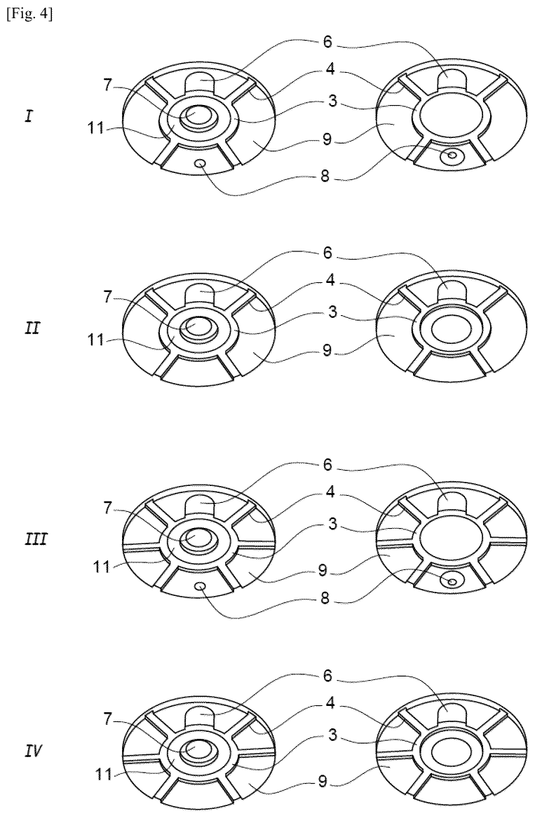

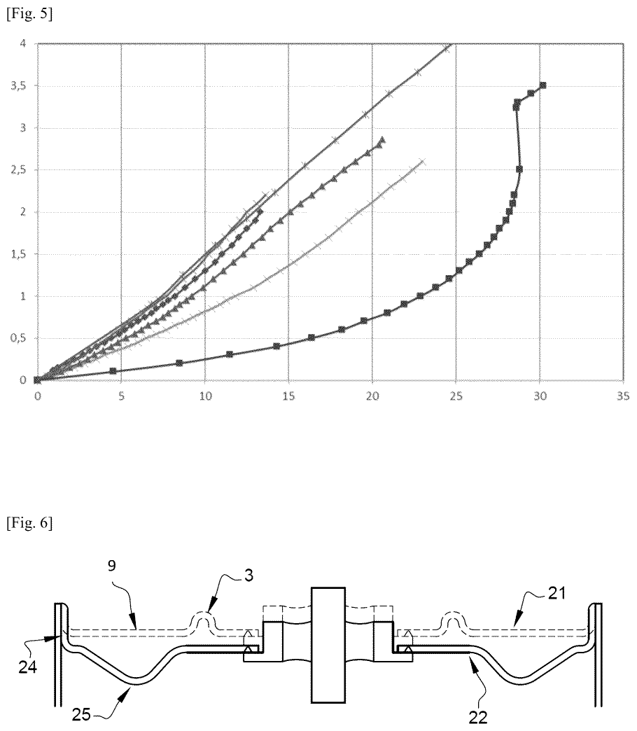

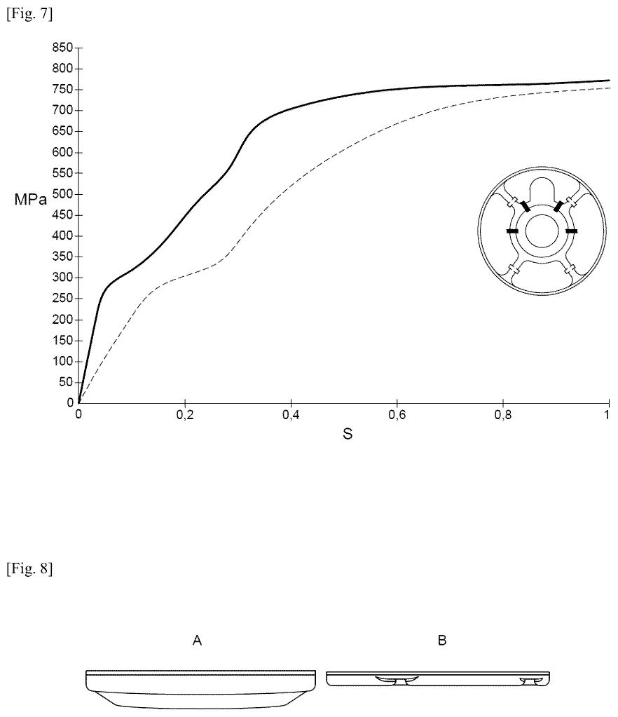

The term “thinned region” is understood to mean a region of reduced thickness compared with the thickness of the projection. The thinned region may be defined as a weakening intended to break under the effect of an increase in the internal pressure of the cell. The thickness of the projection is referenced e 1 and the thickness of the thinned region is referenced e 2 in FIG. 2.

The cover according to the invention includes at least four projections. preferably the cover may include 4 to 6 projections. The cover is disposed on the container of the cell such that the projections are oriented outward from the cell.

The cover according to the invention may include one or more thinned regions located:
on at least one of the four projections, and/or
on the crown-shaped boss, and/or
on at least one of the at least two planar regions.

According to one embodiment, a thinned region is present on two of the four projections.

According to another embodiment, a thinned region is present on four projections.

According to one embodiment, the thinned region is present only at one or more projections but not on the crown-shaped boss.

According to another embodiment, the thinned region is present only on the crown-shaped boss.

According to one embodiment, the thinned region is present both on one of the at least four projections as well as on the crown-shaped boss.

According to one embodiment, the crown-shaped boss includes one or more thinned regions, preferably the crown-shaped boss includes one to four thinned regions.

According to one embodiment, the thinned region is present on at least one of the at least two planar regions.

According to another embodiment, the thinned region is present on at least one of the at least four projections as well as on at least one of the at least two planar regions.

According to one embodiment, the thinned region is present on the crown-shaped boss and on at least one of the at least two planar regions.

According to one embodiment, the thinned region is present both on at least one of the at least four projections, on the crown-shaped boss and on at least one of the at least two planar regions.

The thinned region may have various shapes. Preferably, the thinned region is rectangular, chevron or almond-shaped. Advantageously, the thinned region is almond-shaped. Almond-shaped promotes a sharp clean break of the thinned region.

According to one embodiment, the projections each extend along a non-radial axial direction, no axial direction being parallel to another.

The role of the projections of the cover according to the invention is to stiffen the cover when facing an increase in internal pressure. In addition, the extensions of each of the projections do not intersect at the center of the cover (at least 4 axes of non-radial direction), which allows a more homogeneous distribution of forces applied to the cover and to minimize deformation of the cover when it is subjected to an increase in internal pressure of the cell.

The thinned region is intended to break under the effect of a predefined pressure, thus allowing the evacuation of gases. The pressure at which at least one of the thinned regions breaks generally ranges from about 25 to 35 bar.

The crown-shaped boss located between the inner circumference and the outer circumference makes it possible to distribute stress and limit the length of the projections. It thus makes it possible to avoid the formation of brittleness region.

### Connection Regions

The cover according to the invention further includes two separate interfacing regions of polarities that may be identical or opposite.

The first interfacing region is located between the crown-shaped boss and the outer circumference of the ring, and the second interfacing region of polarity possibly identical or opposite to the first one is located in the space delimited by the inner circumference of the ring.

Thus, the cover according to the invention has the advantage of possibly having on the same face the connection regions of the two electrodes. This makes it possible to facilitate the assembly of the electrochemical cells in series.

The first interfacing region may be a negative polarity electrode connection region and the second interfacing region an electrode connection region of positive polarity, or vice versa, or the same.

The second interfacing region may be isolated from the cover by various means.

According to one embodiment, the second interfacing region is isolated from the cover by a glass-metal feedthrough (TVM) junction comprising a glass insulator and a metal fixing means, also called a base, said fixing means being fixed to the cover by welding.

This welding can be carried out by electrical welding or by laser welding.

In the case where the cover is placed on a cell of format C or D, the glass-metal feedthrough (TVM) is preferably welded to the cover by an electric weld.

In the case where the cover is placed on a cell of format A, AA, 1/2 AA, the glass-metal feedthrough (TVM) is preferably welded from the back by a laser weld, that is to say that the laser beam is arranged on the side of the cover intended to be oriented towards the inside of the cell.

The production of a glass-metal feedthrough is achieved by techniques well known to those skilled in the art. This type of feed-through guarantees in particular the gas-tight sealing of the glass as well as good resistance to high pressures and high temperatures.

According to another embodiment, the second interfacing region is isolated from the cover by a safety member such as a circuit breaker comprising a polymer insulator.

It is advantageous to have one or more thinned regions on the ring in the vicinity of the first interfacing region, as illustrated by the view of the cover of FIG. 8.

### Planar Region in the Shape of a Kidney Bean

The cover includes at least two planar regions in the form of an arc of a circle situated between the crown-shaped boss and the outer circumference of the ring, the cover being seen in a direction perpendicular to the plane of the ring. Preferably, the cover includes two, three or four planar regions, more advantageously, the cover includes two planar regions.

These flat-bottomed regions have the role of damping the swelling of the cover. Indeed, under the effect of pressure, these planar regions will absorb the gases and if necessary deform towards the outside until the thinned portion on the projections ruptures. However, the deformation of these planar regions remains controlled because it does not lead to deformation of the walls of the container of the cell beyond what is admissible.

FIG. 6 compares two cover profiles, one 21 shown in dotted lines and corresponding to the cover according to the invention, the other 22 shown in solid line and corresponding to a cover of the prior art as described for example in document CN 101847749B. The crown-shaped boss 3, characteristic of the cover according to the invention, is visible in this figure. In both cases, the cover is traversed by a junction of the glass-metal feedthrough type (TVM). These two covers are fixed by their outer edge to the opening of the container of the cell. In each of the two profiles, a return 24, constituted by a bending of the sheet at right angles, bears against the inner wall of the container. This return constitutes a contact surface between the cover and the inner wall of the container and facilitates the closure of the container by welding the cover thereto. It should be noted that in the case of the cover according to the prior art, the return is contiguous with a portion in the form of a deformed “V” 25 towards the inside of the cell. This portion in the form of a “V”, the tip of which is directed towards the inside of the cell, is intended to deform in the direction of the outside of the cell in the event of an overpressure inside the cell. In contradistinction, it should be noted that in the case of the cover according to the invention, the return is contiguous with a flat horizontal part 9, perpendicular to the longitudinal axis of the cell. The invention makes it possible to increase the available internal volume of the cell in order to house the electrodes therein. The replacement of the portion in the form of a “V” by a flat horizontal portion makes it possible to gain a few millimeters. This explains why the height of a conventional cover is approximately 4.5 mm whereas that of a cover according to the invention is only about 2 mm. In this way, capacity is obtained. The gain in volume is materialized by the vertical arrow pointing upwards on the axis of symmetry of the cell. The presence of the flat horizontal part of the cover according to the invention is not to the detriment of the rigidity of the cover, neither to the detriment of the safety of the user. Indeed, firstly, the projections and the ring make it possible to stiffen the cover. The projections and the ring are oriented towards the outside of the cell. This orientation therefore does not penalize the available internal volume. Secondly, the presence of thinning makes it possible to guarantee the safety of the user.

### General Features of the Cover

The cover according to the invention may be made of stainless steel, nickel-plated steel or aluminum. Preferably, the cover is made of stainless steel.

The cover has a height greater than or equal to 1.6 mm and less than 4 mm, preferably between 2 and 3 mm.

The height of the cover according to the invention is reduced compared with that of standard covers.

### Filling Port for Electrolyte

According to one embodiment, the cover includes an orifice for filling a cell with an electrolyte, said orifice being located in a hollow region of the surface of the ring.

This hollow region makes it possible to collect electrolyte residues which would be flowing during the filling of the cell and thus prevent them from spreading on the cover.

Once the electrolyte has been introduced, a ball is welded at this orifice to close it.

The hollow area also allows self-centering of the ball. The fact of disposing the filling orifice on the cover makes it possible to provide a container with a flat bottom and therefore to gain in internal volume. In addition, the filling of the cell via the cover makes it possible to simplify the manufacturing process because it makes it possible to avoid an additional step consisting in turning the cell over to perform the filling.

The presence of a filling orifice on the bottom of the container could weaken the bottom of the container because the latter bears on a surface supporting the cell.

### Electrochemical Cell

The second subject of the present invention is an electrochemical cell comprising:
a container housing an electrode plate group,
one end forming a bottom and
an end opposite the end forming a bottom,
wherein said end opposite the end forming the bottom is closed by a cover as defined in the present invention.

According to one embodiment, the volume of material of the cover occupies between 10 and 15% of the total volume of the container.

According to another embodiment of said cell, the volume allocated to a set of connections, to an electrolyte and to the electrochemical plate group represents at least 95% of the volume available in the container.

According to one embodiment, the end forming the bottom of the cell includes an orifice intended for filling the cell with the electrolyte.

The electrochemical cell may be a primary or secondary type cell.

The format of the cell may be cylindrical or prismatic, preferably it is cylindrical. The diameter of the container is not limited.

In the case of a secondary cell, mention may be made, for example, of cells of the lithium-ion, Ni/MH or Ni/Cd type. Preferably, the cell is of the lithium-ion type. The secondary cell preferably includes one or more safety devices disconnecting the electrodes from a given polarity to their corresponding polarity current output terminal in the event of an overpressure inside the container. These devices supplement the thinning regions which only release the gases out of the cell.

In the case of cells of the primary type, mention may be made, for example, of cells of the Li/MnO₂, Li/CF, Li/SO₂, Li/SOCh and Li/SOCh type.

### Manufacturing Process

The third subject matter of the present invention is a method for manufacturing the cover as defined in the present invention, said method comprising the following steps:
(a) Stamping a sheet, to form a ring having:
   an outer circumference and an inner circumference,
   a crown-shaped boss located between the inner circumference and the outer circumference,
   at least two planar regions in the form of an arc of a circle, located between the crown-shaped boss and the outer circumference of the ring, the cover being seen in a direction perpendicular to the plane of the ring,
   at least four projections extending from the crown-shaped boss towards the outer circumference along non-radial axes;
(b) forming a thinned region on at least one of the four projections and/or on the crown-shaped boss and/or on at least one of the at least two planar regions; step (b) can be carried out after step (a) or before step (a) at the locations provided on the sheet for the creation of the crown-shaped boss and of said at least four projections by stamping;
(c) Placing an insulated interface terminal in the space delimited by the inner circumference of the ring;
(d) Welding the interfacing terminal to the part obtained in step (b).

The term “stamping” means a method which consists in shaping a metal part from a metal sheet or from a sheet.

The thinning may be carried out by any forming method, in particular by magnetoforming, by laser ablation, by mechanical machining or by chemical etching.

The length of the thinned region may represent 50 to 110% of the width of a projection or of the width of the crown-shaped boss.

The thickness of the thinned region may range from 25 to 40% of the initial thickness of the sheet.

For a sheet thickness of between 0.4 and 0.5 mm, the residual thickness of the thinned region may be between 0.05 and 0.20 mm, preferably between 0.120 mm and 0.180 mm.

According to one embodiment, step (b) is carried out by stamping or by removing material. Preferably, by stamping.

According to one embodiment, the insulated interfacing terminal corresponds to a glass-metal feedthrough.

The manufacturing method according to the invention makes it possible to obtain covers of reduced height. Indeed, as shown in FIG. 8, the cover of the prior art (A) has a height of 4.25 mm while the cover according to one embodiment of the invention (B) has a height of 2 mm.

Consequently, in addition to the internal volume gain, the manufacturing method makes it possible to save on material, which is significant.

### EXAMPLES

### Example 1

Tests were carried out in order to evaluate the displacement in the direction of the longitudinal axis of the cell, (in millimeters) of a cylindrical cell according to the invention and of a standard cylindrical cell of the same size, as a function of their internal pressure expressed in bar.

The results are presented in FIG. 5 and show that the cell according to the invention undergoes deformation in the direction of its longitudinal axis similar to that of a standard cell. Consequently, a cover according to the invention meets safety standards just as well as a standard cell.

### Example 2

Two prototypes of a “D” format cell were produced, one comprising a cover according to the invention as shown by the reference 21 in FIG. 6 and the other a standard cover as shown by the reference 22 in FIG. 6. The characteristics of these cells are listed below.

TABLE 1

| | |
|---|---|
| Cell with cover | Cell with |
| according to | standard |
| the invention | cover |

| | | | | |
|---|---|---|---|---|
| Total height | 60.65 | mm | 60.98 | mm |
| Internal volume | 45.41 | cm³ | 42.38 | cm³ |
| Capacity | 18.5 | Ah | 17 | Ah |

The results presented in the table above reveal that for a dimension of equivalent cells, the cell comprising a cover according to the invention has an internal volume greater than that of the standard cell as well as increased capacity.

### Example 3

Tests were carried out in order to evaluate the effect of the position of the thinned regions on the cover. These tests consist in introducing gas into a cell whose cover includes a thinned region on at least one of the projections lines (in dotted lines) and in a cell whose cover includes at least one thinned region arranged only on the crown-shaped boss (solid lines). The results are shown in FIG. 7.

It is observed that the pressure increases faster in the cell whose cover includes the thinned regions at the crown-shaped boss. For example after 0.2 seconds, the pressure measured in this cell is 450 MPa while it is 300 MPa for the cell whose cover includes the thinned regions at the projections. It is then possible to deduce therefrom that the latter type of cell deforms more since for the same quantity of gas introduced, the internal pressure is less.

Therefore, the position of the thinned regions can be varied, that is to say to arrange them either on the projections, or on the ring, as a function of the desired tear pressure. It is also possible to vary their number and shapes as a function of the desired tear pressure.

1. A cover for an electrochemical cell, comprising:
a ring, said ring having an outer circumference and an inner circumference,
a crown-shaped boss located between the inner circumference and the outer circumference,
at least two circular arc-shaped planar areas, located between the crown-shaped boss and the outer circumference of the ring, the cover being seen in a direction perpendicular to the plane of the ring,
at least four projections extending from the crown-shaped boss toward the outer circumference along a non-radial axis,
wherein a thinned region is present on at least one of these four projections and/or on the crown-shaped boss and/or on at least one of the at least two planar areas.

2. The cover according to claim 1, comprising two separate interfacing regions of identical or opposite polarities.

3. The cover of claim 2, wherein the first interfacing region is located between the ring-shaped boss and the outer circumference of the ring, and the second interfacing region of the same or opposite polarity to the first polarity is located in a space defined by the inner circumference of the ring.

4. The cover according to claim 3, wherein the second interfacing region is insulated from the cover by a glass-metal feedthrough comprising a glass insulator and a metal fixing means, said fixing means being fixed to the cover by welding.

5. The cover according to claim 3, wherein the first interfacing region is a negative polarity electrode connecting region and the second interfacing region is a positive polarity electrode connecting region.

6. The cover according to claim 1 wherein, the thinned region is rectangular, chevron or almond-shaped.

7. The cover claim 1, wherein each projection includes a thinned region.

8. The cover according to claim 1, wherein said at least four projections each extend along a non-radial direction axis, wherein no direction axis is parallel to another.

9. The cover according to claim 1, comprising between 2 and 4 planar regions in the form of an arc of a circle, located between the crown-shaped boss and the outer circumference of the ring, the cover being viewed in a direction perpendicular to the plane of the ring.

10. The cover according to claim 1, the height of which is greater than or equal to 1.6 mm and less than 4 mm, preferably between 2 and 3 mm.

11. The cover according to claim 1, comprising an orifice for filling a cell with an electrolyte, said orifice being in a hollow region of the surface of the ring.

12. The cover according to claim 1, wherein said cover is made of stainless steel, nickel-plated steel or aluminum.

13. An electrochemical cell comprising:
a container housing an electrode plate group,
an end forming a base, and
an end opposite the end forming a base,
wherein said end opposite to the end forming a base is closed by a cover as defined in claim 1.

14. The electrochemical cell of claim 13, wherein the volume allocated to a set of connections, an electrolyte and the electrochemical plate group makes up at least 95% of the volume available in the container.

15. The electrochemical cell according to claim 13 of the lithium-ion, Ni/MH or Ni/Cd type.

16. The electrochemical cell according to claim 13 of the primary lithium type selected from the group comprising: LiMnO₂, LiCFₓ, LiSO₂, LiSOCl₂ and LiSO₂Cl₂.

17. A method of manufacturing the cover as defined in claim 1, comprising the steps of:
(a) stamping a sheet, to form a ring having:
an outer circumference and an inner circumference,
a crown-shaped boss located between the inner circumference and the outer circumference,
at least two circular arc-shaped planar areas, located between the crown-shaped boss and the outer circumference of the ring, the cover being seen in a direction perpendicular to the plane of the ring,
at least four projections extending from the crown-shaped boss toward the outer circumference along a non-radial axis;
(b) forming a thinned region on at least one of the four projections and/or the crown-shaped boss and/or on at least one of the at least two planar areas; step (b) being performed after step (a) or before step (a) at the locations provided on the sheet for creating the crown-shaped boss and said at least four projections by stamping.
(c) providing an insulated interfacing terminal in the space defined by the inner circumference of the ring;
(d) welding the interfacing terminal to the part obtained in step (b).

18. The method according to claim 17, wherein step (b) is carried out by stamping or removing material.
